(19) United States
(12) Patent Application Publication
(10) Pub. No.: US 2025/0033941 A1
(43) Pub. Date: Jan. 30, 2025

(54) HANDLING MACHINE COMPRISING A HYDRAULIC STEERING SYSTEM

(71) Applicant: Manitou BF, ANCENIS (FR)

(72) Inventors: Hervé MERTEN, ANCENIS (FR); Grégory BIDET, ANCENIS (FR)

(21) Appl. No.: 18/716,847

(22) PCT Filed: Nov. 17, 2022
(86) PCT No.: PCT/FR2022/052114

§ 371 Date: Jun. 5, 2024

(30) Foreign Application Priority Data
Dec. 8, 2021 (FR) FR2113162

(51) Int. Cl. B66F 9/075; B62D 5/07; B62D 5/30; E02F 3/96; E02F 9/22

(52) U.S. Cl. CPC B66F 9/07568; B62D 5/075; B62D 5/30; E02F 3/96; E02F 9/2203; E02F 9/225; E02F 9/226

(57) ABSTRACT

The invention relates to a handling machine comprising a hydraulic steering circuit (3), a first hydraulic control circuit (100), provided with a manual steering device (4), which allows steering cylinders (31-34) of the hydraulic steering circuit (3) to be supplied with power, and a second hydraulic control circuit (200) which is used to control at least one hydraulic actuation cylinder (5) for actuating a handling member of the machine. The second circuit (200) comprises a hydraulic directional control valve (210), a hydraulic connection circuit (600) which is connected to the steering circuit, and a diverter valve (220) to which the connection circuit (600), the hydraulic actuation cylinder (5) and the hydraulic directional control valve (210) are connected. The diverter valve (220) is electrically controllable by a control unit (10) to selectively control the hydraulic actuation cylinder (5) and the same steering cylinders as those which are controllable by the first control circuit (100).

### FIELD OF THE INVENTION

The present invention is generally concerned with handling machines including a hydraulic steering system.

### PRIOR ART

A handling machine known from the prior art depicted in FIG. 1 comprises hydraulic steering systems for steering the front and rear wheels of the machine.

Such a hydraulic steering system includes a steering circuit connected to a front steering cylinder system VDAV and a rear steering cylinder system VDAR. The hydraulic steering system also includes a steering pump PDD and a mechanical control device such as a steering wheel VDD. The steering wheel is for directing oil to one or the other of channels R, L connected to the steering pump PDD. A selector S1 enables selection of the mode of operation of the steering circuit. The steering pump PDD has a channel T connected to an oil tank and a channel P connected to a feed pump.

However, known hydraulic steering systems that use mechanical control devices do not offer any possibility of reliable, simple and safe electrical control of the hydraulic steering system to provide either an assistance or an autonomy function for maneuvering or driving the handling machine.

The present invention has for object proposing a corresponding handling machine making it possible to alleviate some or all of the problems set out hereinabove.

### SUMMARY OF THE INVENTION

To this end the invention has for object a handling machine including:
a mobile chassis;
a handling system comprising at least one handling member that can be actuated by a hydraulic cylinder, such as a cylinder for inclining a tool-holder of the machine;
a steering system comprising:
a hydraulic steering circuit including steering cylinders for steering at least some of the wheels of the machine;
a first hydraulic control circuit connected to the steering circuit to be able to feed the steering cylinders and a manual steering device such as a steering wheel connected to the first hydraulic control circuit;
a second hydraulic control circuit used at least to control the actuator hydraulic cylinder of a handling member;
characterized in that:
the second hydraulic control circuit includes:
a hydraulic distributor;
a hydraulic connection circuit connected to the hydraulic steering circuit; and
a diverter to which are connected the connecting circuit, the hydraulic cylinder for actuating a handling member, and the hydraulic distributor;
the diverter being electrically controllable to assume selectively:
a first state in which the hydraulic distributor of the second hydraulic control circuit is connected to the actuator hydraulic cylinder of said handling member; and
a second state in which the hydraulic distributor of the second hydraulic control circuit is connected to the connecting circuit that is connected to the steering circuit to enable the second hydraulic control circuit to control the same steering cylinders as those controllable by the first hydraulic control circuit;
a control unit configured to control the diverter to place it in the second state in which the hydraulic distributor is connected to the connecting circuit that is connected to the steering circuit in order to be able to execute a handling machine steering control program, for example for parking the handling machine automatically in a given place.

Thus the handling machine includes an electro-hydraulic circuit for controlling the steering circuit that is installed in parallel with the conventional mechanically-controlled hydraulic control circuit.

There is thus obtained a possibility of electrically controlled hydraulic steering enabling either provision of assistance through steering control or rendering the steering control autonomous while limiting additional components and retaining a mechanical control device such as a steering wheel for mechanically controlling the hydraulic steering circuit.

The steering system of the handling machine therefore offers the benefit of an architecture with a dual system for controlling the hydraulic steering circuit able to function in parallel with, independently of or in addition to one another.

The steering system may in particular include:
the original type approved hydraulic steering system of the handling machine for controlling the hydraulic steering circuit of the machine using a hydraulic control circuit controlled by a mechanical control device such as a steering wheel, and
an electrically-controllable hydraulic control system of the steering circuit that can reuse part of a hydraulic distributor of the hydraulic circuit of the machine for selectively controlling a hydraulic cylinder for actuating an element of the handling system of the machine and the hydraulic steering circuit of the machine.

To control the steering of the machine with the aid of the second control circuit the control unit also controls the hydraulic distributor to feed a given flowrate to one or other channel of the connecting circuit. The control unit can also control one or more other members for controlling the movement of the machine.

In the case of a modified machine the original hydraulic steering circuit is retained so that the type approval of the machine is not downgraded.

Steering speed variation can be controlled by a proportional slide valve of the distributor (for example an original equipment distributor) of the electrohydraulic control circuit of the machine.

The machine may also have one or more of the following features in any technically permissible combination.

In accordance with one embodiment of the invention the steering system is configured so that the first hydraulic control circuit remains controllable by the driver of the handling machine using the manual steering device to act on the steering circuit, complementing or correcting the second hydraulic control circuit.

In accordance with one embodiment of the invention the first control circuit, the second control circuit and the steering circuit act on the same lines of the steering circuit so that the second control circuit is adapted to act on the steering of the same wheels as those on which the first control circuit is adapted to act, and vice versa.

In other words, for a given state of the selector when the machine includes a selector the wheels on which the second control circuit acts via the steering circuit are the same as those on which the first control circuit acts.

In accordance with one embodiment of the invention the handling machine includes front wheels and rear wheels, the steering circuit being configured to enable steering of at least the front wheels.

In accordance with one embodiment of the invention the second hydraulic control circuit is connected to lines of the steering circuit that are connected to the first hydraulic control circuit.

In accordance with one embodiment of the invention the steering circuit includes a selector for selecting the wheels to be steered.

In accordance with one embodiment of the invention, the steering circuit including a selector for selecting the wheels to be steered, the second hydraulic control circuit is connected to the steering circuit between the first control circuit and the selector.

In accordance with one embodiment of the invention the steering circuit includes a selector configured to be able to adopt a plurality of states selectively, said states including:
a state in which the lines of the steering circuit are configured so that only the front wheels are steerable with the aid of the hydraulic steering circuit;
a state in which the lines of the steering circuit are configured so that the front wheels and the rear wheels are steerable in the same sense with the aid of the hydraulic steering circuit; and
a state in which the lines of the steering circuit are configured so that the front wheels and the rear wheels are steerable in opposite senses to one another with the aid of the hydraulic steering circuit.

In accordance with one embodiment of the invention a line of the second hydraulic control circuit is connected to a line of the steering circuit that extends between the selector and the first hydraulic control circuit.

In accordance with one embodiment of the invention another line of the second hydraulic control circuit is connected to a line of the steering circuit that extends between a steering cylinder, preferably a front wheel steering cylinder, and the first hydraulic control circuit.

In accordance with one embodiment of the invention the hydraulic cylinder for actuating a handling member is a cylinder for inclining a tool-holder of the handling machine.

In accordance with one embodiment of the invention at least one of the first and second control circuits and preferably each of them includes a pressure limiter device.

In accordance with one embodiment of the invention at least one of the pressure limiter devices and preferably each of them includes a dual balancing valve.

In accordance with one embodiment of the invention the pressure limiter device of the first control circuit is situated between a steering pump of the first control circuit and the hydraulic steering circuit.

In accordance with one embodiment of the invention the pressure limiter device of the second control circuit is situated in the connecting circuit.

To enable the steering circuit to be controlled by two independent control circuits, namely a mechanically-actuated control circuit and an electrically-actuated control circuit, without said control circuits interfering with each other, each control circuit may include a controlled pressure limiter device.

To avoid having to add a component such as a hydraulic power source of the electro-hydraulic control circuit (known as the second circuit), the electro-hydraulic control circuit may re-use a segment (part) of an electro-proportional control hydraulic distributor already present in the hydraulic circuit of the handling machine and used initially to control an actuator cylinder of an element of the handling system of the machine, such as an actuator for inclining a tool-holder of the machine. The diverter may be added by connecting it on the one hand to a pair of channels of said part of the hydraulic distributor and on the other hand to a hydraulic circuit connected to the steering circuit.

### BRIEF DESCRIPTION OF THE DRAWINGS

Other features and advantages of the invention will emerge further from the following purely illustrative and non-limiting description that must be read with reference to the following appended drawings, in which:

FIG. 1 is a schematic view of a steering system of one example of a handling machine known from the prior art;

FIG. 2 is a schematic view of a steering system of a handling machine in accordance with one embodiment of the invention;

FIG. 2A is a schematic view of a part of the steering system from FIG. 2;

FIG. 3 is a schematic view of a pressure limiter device of a steering system for a handling machine in accordance with one embodiment of the invention;

FIG. 3A is a schematic view of the pressure limiter device from FIG. 3 in a first operating state;

FIG. 3B is a schematic view of the pressure limiter device from FIG. 3 in a second operating state;

FIG. 3C is a schematic view of the pressure limiter device from FIG. 3 in a third operating state;

FIG. 4 is a schematic view of a handling machine in accordance with one embodiment of the invention.

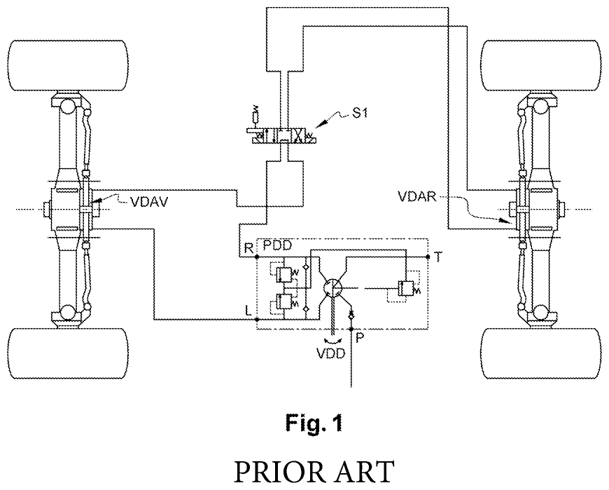

### DETAILED DESCRIPTION

The concept of the invention is described more completely below with reference to the appended drawings which show embodiments of the concept of the invention. In the drawings the sizes and the relative sizes of the elements may be exaggerated for clarity. Similar numbers refer to similar elements in all the drawings. However, this concept of the invention can be implemented in numerous different forms and should not be interpreted as being limited to the embodiments described here. Rather than that, these embodiments are offered so that this description is complete and communicates the extent of the scope of the invention to persons skilled in the art.

A reference throughout the specification to “an embodiment” means that a functionality, a structure or a particular feature described with reference to one embodiment is included in at least one embodiment of the present invention. Thus the occurrence of the expression “in one embodiment” at various places throughout the specification does not necessarily refer to the same embodiment. Furthermore, the functionalities, structures or particular features may be combined in any appropriate manner in one or more embodiments.

There is proposed a handling machine that includes a steering system for steering at least some of the wheels, preferably at least the front wheels, with the aid of a manual control device such a steering wheel and/or with the aid of electrical control that is either autonomous or complements manual control.

The handling machine includes a mobile chassis that carries a person or a load-handling system such as a lifting arm equipped at its end with a tool-holder and a tool coupled to the tool-holder. The handling system includes a system of cylinders for actuating one or more elements of the handling system. The system of cylinders of the handling system can for example include a cylinder for actuating the lifting arm and an inclination cylinder for inclining the tool-holder relative to the arm.

### Handling Machine

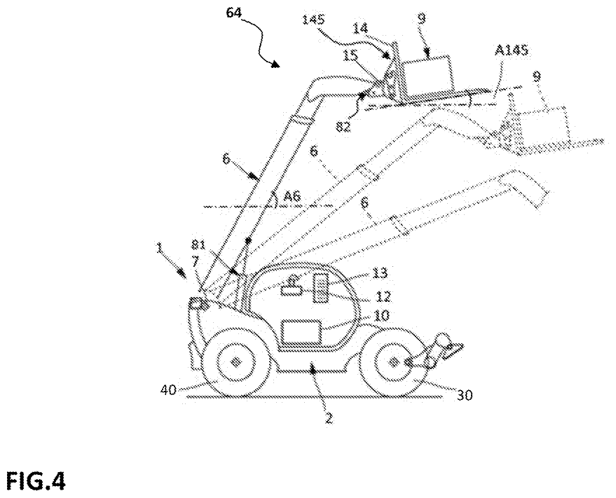

In FIG. 4 there has been represented an example of a handling machine 1 in accordance with one embodiment to which the steering system described below is applicable. The handling machine 1 may also be referred to as a handling truck.

The handling system 1 includes a mobile chassis 2 supported on the ground by means of a front axle 30 including two front wheels and a rear axle 40 including two rear wheels.

The handling machine 1 includes a motorized system for moving the machine. The motorized system for moving the machine includes for example an electric motor and/or an internal combustion engine, a transmission system connected to the wheels and a steering system enabling movement and steering of the machine.

The mobile chassis 2 carries a handling system 64. The handling system 64 may include an arm 6, usually called a lifting arm, articulated to the mobile chassis 2 so that it can be moved between a so-called lowered position and a raised position and a handling device 14, 145. Alternatively the handling system 64 may be carried by a turret mounted to pivot on the chassis.

The lifting arm 6 is articulated to the chassis 2 in an area closer to the rear axle than the front axle.

The handling device 145, 14 is articulated at one end of the lifting arm 6. A system of cylinders includes a cylinder 81 for moving said lifting arm relative to the chassis 2 and a cylinder 82 for moving the handling device 145, 14 relative to the lifting arm 6.

The handling machine includes a control unit 10 including for example a computer that enables the operator, via a human-machine interface that may include a control member 12 such as a joystick, to control the handling machine and in particular to control the direction of movement (forward-backward) of the machine and/or the position of the arm 6 and/or of the handling device 145,14.

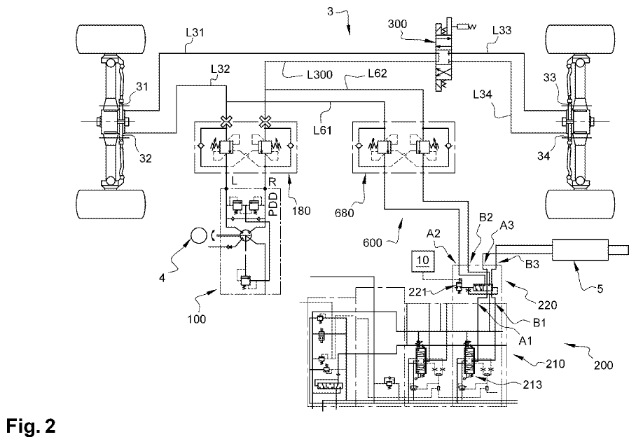

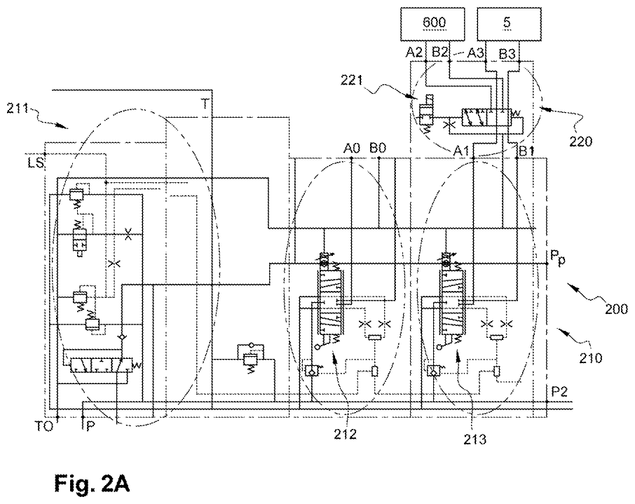

As described in detail below with reference to FIGS. 2 and 2A the control unit 10 can also be used to control a control circuit 200 of the steering circuit 3. The handling machine also includes a steering wheel 4 for manually controlling another control circuit 100 of the steering circuit 3 as described in detail below.

The lifting arm 6 (also known as the handling arm) is mounted on the chassis 2 and can be oriented about a rotation axis 7. In particular said rotation axis 7 is horizontal when the mobile chassis 2 is resting on horizontal ground. The arm 6 projects toward the front of the machine.

In other words the arm 6 is configured to pivot about an axis transverse to the longitudinal axis of the machine (a horizontal axis when the machine is resting on horizontal ground) to be moved between a lowered position and a raised position.

The lifting arm 6 forms a reference angle A6 with a reference such as the horizontal (or the plane in which the machine rests on the ground). In FIG. 4 the carriage plate 145 is inclined relative to a reference such as the horizontal at a reference angle A145.

The arm enables different angles of inclination relative to the plane in which the wheels of the machine rest on the ground to be obtained, and in particular in a raised position a maximum angle for example between 55° and 70° inclusive relative to the plane in which the wheels of the machine rest on the ground.

In accordance with one embodiment the minimum angle that the arm in the lowered position can reach relative to the plane in which the wheels of the machine rest on the ground is for example between −5° and 5° inclusive. The arm advantageously has a range of angular movement of at least 50°.

### Handling Device

The handling device includes a tool-holder 145, also known as a carriage plate, and a handling tool 14 fixed to the tool-holder in a demountable manner. The tool-holder is able to receive different types of handling tools. Alternatively the tool may be integral with the tool-holder (that is to say non-demountable).

The tool-holder 145 is mounted on and articulated relative to the lifting arm 6. The handling device is articulated to the arm 6 by a connection 15 with an axis parallel to the axis 7 and configured to be able to carry out different operations depending on the handling tool coupled to the carriage plate.

In the example depicted in FIG. 4 the handling tool includes forks for handling a load 9 such as a pallet or a straw bale but the forks can be replaced by different tools, for example a bucket.

In the example depicted in FIG. 4 the arm 6 is of the telescopic type. Thus the arm 6 comprises at least two segments that can be deployed with the aid of a deployment cylinder, not represented, arranged between the at least two segments. Alternatively the arm may be a non-telescopic arm.

As stated hereinabove a human-machine interface that includes the control member 12 is connected to the control unit 10 which is therefore able to control the cylinders 81, 82 via a hydraulic circuit as a function of the manipulation by the operator of the control member 12 such as a joystick. The human-machine interface may also include a screen 13 enabling the operator to obtain feedback on the actions that they are carrying out, for example.

To control the system of hydraulic cylinders of the handling system the hydraulic circuit of the handling machine includes a source of hydraulic pressure and a hydraulic distributor between the source of hydraulic pressure and a control solenoid valve for each hydraulic cylinder. Each control solenoid valve can be controlled by the control unit 10.

The handling machine also includes a steering system that includes a hydraulic steering circuit described below.

### Hydraulic Steering Circuit

The steering system of the handling machine includes a hydraulic steering circuit 3 that includes steering hydraulic cylinders associated with the wheels of the machine and feed channels of those cylinders. The steering system of the machine described below may be applied to a handling machine such as the one described with reference to FIG. 4 but equally well to other handling machines that include a handling system including at least one hydraulic cylinder for actuating an element of the handling system.

In accordance with one embodiment depicted in FIG. 2 the steering cylinders include a system of cylinders 31, 32 associated with the front wheels (front axle) that can be fed by channels L31, L32 and a system of cylinders 33, 34 associated with the rear wheels (rear axle) that can be fed by channels L33, L34.

Each cylinder system associated with the front or rear wheels may include two distinct cylinders each including a cylinder body and a piston mounted to slide inside the cylinder body and mounted on a piston rod that exits the body of the cylinder on one side in order to be coupled to a wheel. Alternatively each cylinder system may include two cylinders including a common cylinder body and two pistons mounted to slide inside the body, each piston being mounted on a piston rod that exits the body of the cylinder on the side opposite the other piston rod.

A selector 300 enables oil from the hydraulic steering circuit 3 to be directed either to the front steering cylinders only or to the front and rear steering cylinders. In particular, depending on the mode selected by the selector the rear steering cylinders may be controlled in the same sense as the front steering cylinders or in the opposite sense.

The steering circuit 3 also includes a line L300 connected on the one hand to a line or channel of a first hydraulic control circuit 100 and to a line or channel of a second hydraulic control circuit 200 described below and on the other hand to the selector 300. Depending on the position of the selector the line L300 may be connected directly to the line L31 so that only the front wheels can be steered or to the line L34 so that the rear wheels can be steered in the same sense as the front wheels (the line L33 being then in communication with the line L31), or to the line L33 so that the rear wheels can be steered in the same sense to the front wheels (the line L34 being then in communication with the line L31).

### First Hydraulic Control Circuit

A first hydraulic control circuit 100 is connected to the hydraulic steering circuit 3 so as to be able to feed some or all of the steering cylinder systems.

The first hydraulic control circuit 100 may be an original equipment hydraulic control circuit of the handling machine and the machine modified to add the control circuit 200 described below.

The steering system of the machine includes a steering wheel 4 connected to a steering pump PDD of the first hydraulic control circuit 100 so as to be able to direct oil via one of the channels L, R of the first hydraulic control circuit 100 that are connected to the hydraulic steering circuit 3.

Thus oil can be sent via the channel L of the first hydraulic control circuit 100 by turning the steering wheel 4 one way and via the other channel R by turning the steering wheel 4 the other way.

In accordance with one embodiment the channel L is connected to the line L32 of the front cylinder system and the channel R is connected to the line L300 that is connected to the selector 300 for either feeding via the line L300 only the other line L31 of the front cylinder system or feeding one or the other of the lines L33, L34 of the rear cylinder system, depending on the selected mode (state) of the selector.

As described in detail below, in accordance with a preferred embodiment a pressure limiter device 180 is included in the control circuit 100, preferably between the steering pump PDD and the steering circuit 3.

### Second Hydraulic Control Circuit

A second hydraulic control circuit 200 is used to enable selective control of at least one actuator cylinder 5 of a member of the handling system such as a cylinder for inclining a tool-holder of the machine and to control the hydraulic steering circuit 3 as described in detail below.

The hydraulic steering circuit 3 can therefore be fed by the first hydraulic control circuit 100 and the second hydraulic control circuit 200. The first hydraulic control circuit 100 controllable by the operator using the steering wheel 4 makes it possible if necessary to counter the second hydraulic control circuit 200 that is controllable by a control unit.

As described in detail below the second hydraulic control circuit 200 may therefore be used in addition to (in order to assist) the first hydraulic control circuit 100 or without the first hydraulic control circuit 100, for example for autonomous control of the hydraulic steering circuit 3.

The second hydraulic control circuit 200 includes a hydraulic distributor 210 with proportional electrical control.

As depicted in FIGS. 2 and 2A the hydraulic distributor 210 includes a part (or segment) including two lines A1, B1 for feeding:
either the actuator cylinder 5;
or the steering circuit 3 via the connection circuit 600 described below.

The second hydraulic control circuit 200 is electrically controlled in proportional manner by means of a solenoid valve for supplying to the double line A1, B1 a flowrate corresponding to the required function.

The double line A1, B1 is connected to the diverter 220 to enable selective switching either to the double line A3, B3 of the actuator cylinder 5 or to the double line A2, B2 of the connection circuit that is connected to the steering circuit 3.

The hydraulic distributor 210 may include all or part of an original equipment hydraulic distributor on the machine that is used to control the feed to the cylinder 5, such as a cylinder for inclining a tool-holder of the machine.

In the example depicted in particular in FIGS. 2 and FIG. 2A the hydraulic distributor 210 includes a distributor input plate 211 and a plurality of distributor segments 212, 213. Each distributor segment includes a respective double line A0, B0 or A1, B1. The double line A0, B0 can be used to feed another hydraulic actuator.

In the FIG. 2A example the reference LS corresponds to a load-sensing hydraulic signal and the reference Pp corresponds to a distributor control pressure feed. The references T and TO correspond to a return to the hydraulic fluid tank and the references P and P2 correspond to hydraulic feeds.

### Diverter

The second hydraulic control circuit 200 includes an electrically controllable diverter 220.

The diverter 220 is connected to the double line A1, B1 of a segment (part) of the hydraulic distributor 210. The segment of the hydraulic distributor 210 chosen to be connected to the diverter advantageously enables an appropriate flowrate of oil to be supplied to a steering circuit.

The diverter 220 has:
a first state enabling connection of the two lines A1, B1, that is to say a double line, of the hydraulic distributor 210 of the second hydraulic control circuit 200 to the double lines A3, B3 of an actuator cylinder 5 of said handling member to feed the actuator cylinder 5, and
a second state for connecting the two lines A1, B1 of the hydraulic distributor 210 of the second hydraulic control circuit 200 to a double line A2, B2 of a circuit 600 for connecting the hydraulic distributor 210 to the steering circuit 3 in order to feed the steering circuit 3 via the connection circuit 600.

In the second state the feed lines A3, B3 of the actuator cylinder 5 are no longer connected to the lines A1, B1 with the result that the actuator cylinder 5 is no longer fed.

Thus the diverter 220 enables selection of either a state in which the double line A1, B1 of the hydraulic distributor 210 is in communication with the double line A3, B3 of an actuator cylinder 5 of said handling member so as to feed the actuator cylinder 5 or a state in which the double line A1, B1 of the hydraulic distributor 210 is in communication with the double line A2, B2 in order to feed the steering circuit 3.

The state of the diverter 220, that is to say the selection of connection (or fluidic communication) of the hydraulic distributor 210 to/with the actuator cylinder 5 or the steering circuit 3, is controlled electrically. The diverter 220 therefore includes an electrical control member 221 controllable by a control unit such as the control unit 10 to cause the diverter 220 to go to either the first state or the second state.

In accordance with one embodiment the connection circuit 600 is connected to the steering circuit 3 between the selector 300 and the first control circuit 100.

In the embodiment depicted in FIG. 2 the connection circuit 600 providing the connection between the lines A1, B1 of the hydraulic distributor 210 and the steering circuit 3 is connected to the lines L300, L32 of the front part of the steering circuit 3.

The circuit 600 for connecting the hydraulic distributor 210 to the steering circuit 3 thus includes a line L62 that connects a channel B2 of the diverter 220 to the line L300 of the steering circuit 3. As explained above the line L300 is the line that connects a channel R of the control circuit 100 to the selector 300. The circuit 600 connecting the hydraulic distributor 210 to the steering circuit 3 also includes another line L61 that extends from the channel A2 of the diverter 220 to the line L32 of the steering circuit 3. As explained above the line L32 is the line that connects the other channel L of the control circuit 100 to the cylinder 32 of the system of cylinders of the front wheels.

The diverter 220 connected to the lines A1, B1 of the segment 211 of the hydraulic distributor 210 enables selective benefit of two proportional double lines A2, B2 and A3, B3 from a single double line A1, B1 of a proportional control hydraulic distributor. The electrical control of the diverter is of the all or nothing type.

### Control Unit

The control unit that is used to control the electrical control unit 221 of the diverter 220 and the solenoid valve or valves of the hydraulic distributor 210 may be in whole or in part common to the control unit of the handling machine used to control the handling system of the machine.

The control unit 10 is configured to control the electronic diverter 220 to place it in the second connecting state to connect the hydraulic distributor 210 to the connection circuit 600.

In this second state of the diverter 220 the control unit 10 can be configured to execute a control program for automatic steering of the handling machine, for example to park the handling machine automatically at a given location.

Automatic control of steering of the handling machine is then effected via electrical control of the hydraulic distributor 210 that is connected to the steering circuit 3.

Such a steering system design enables the control unit 10 to control automatically the steering of the machine by actuating the all or nothing electrical control member 221 of the diverter 220 to connect the channels A1, B1 to the channels A2, B2 and proportionally controlling the hydraulic distributor 210 to send the required flowrate via either the line A1 or the line B1 so as to control the steering circuit 3 by means of the connection circuit 600.

In accordance with one embodiment the control unit is also configured to control the selector 300. In the embodiment depicted in the figures the selector 300 enables operation of the machine in a mode in which only the front wheels are steerable by isolating the part called the front part of the steering circuit situated between the selector and the front steering cylinders, which enables feeding of the front wheel steering cylinders from the part called the rear part of the steering circuit situated between the selector 300 and the rear steering cylinders, which enables feeding of the rear wheel steering cylinders.

As mentioned hereinabove, depending on the state of the selector 300 the selector 300 also enables operation of the rear steering cylinders at the same time as the front steering cylinders in the same sense or in opposite senses.

The first hydraulic control circuit 100 preferably remains controllable by the driver using the steering wheel 4 to act on the steering circuit 3, complementing or correcting the electrically-controlled second hydraulic circuit 200.

The electrical control member 221 of the diverter may be placed in the first state when a control input to the hydraulic cylinder 5 is detected, for example when the control unit detects operation by the operator of a control member of the hydraulic cylinder 5.

The or each control unit takes for example either the form of a processor and a data memory in which are stored computer instructions that can be executed by said processor or the form of a microcontroller.

In other words the functions and steps described can be implemented in the form of a computer program or in hardware (for example programmable logic gate networks). In particular, the functions and steps executed by the control unit may be implemented either by sets of instructions or computer modules implemented in a processor or controller or by dedicated electronic components or FPGA or ASIC type components. It is also possible to combine computer parts and electronic parts.

Thus the control unit is an electronic and/or computer unit. When it is specified that said unit is configured to execute a given operation that means that the unit includes computer instructions and the corresponding execution means for carrying out said operation and/or that the unit includes corresponding electronic components.

### Pressure Limiter Device

In accordance with one embodiment at least one of the hydraulic control circuits 100, 200 and preferably each of them includes a pressure limiter device (also known as a hydraulic coupling device).

As depicted in FIG. 2 the first hydraulic control circuit 100 includes a pressure limiter device 180. The connecting circuit 600 of the control circuit 200 also includes a pressure limiter device 680.

The pressure limiter devices 180, 680 enable prevention of disturbance to the first, hydraulic control circuit 100 and the second, electro-hydraulic control circuit 200 relative to one another.

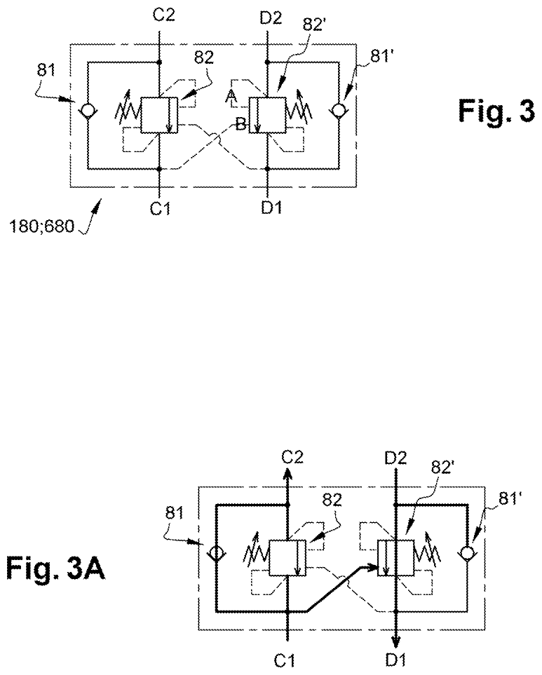

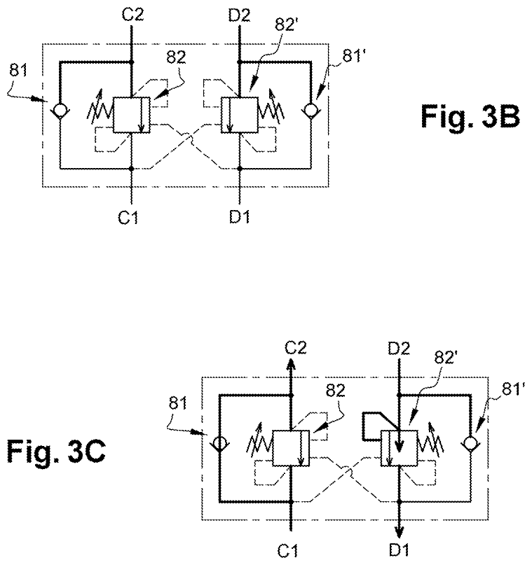

In accordance with one embodiment each pressure limiter device includes a first assembly including a check valve 81 and a valve 82 (on the left in FIG. 3) for controlling the flow of fluid in a line C2, C1 and a second assembly including a check valve 81′ and a valve 82′ (on the right in FIG. 3) for controlling the flow of fluid in a line D2, D1.

FIG. 3 depicts such a component and FIGS. 3A-3C depict operating situations. The pressure limiter device being symmetrical it is half of the operating situations that are described below.

With a rise in pressure at A of the valve 82′, that is to say a control surface at the inlet of the valve 82′, the pressure limiter device behaves like a standard pressure limiter and the valve 82′ therefore opens at the pressure to which the corresponding spring is set (for example 300 bar). In this case the pressure limiter device functions as an “anti-shock valve”.

With a rise in pressure at B, that is to say in the control zone of the valve 82′ connected to a channel of the other valve 82, a control area is used that is greater than, for example 4 to 8 times greater than, the area used at A. The lower pressure, for example 4 to 8 times lower (for example 50 bar), is therefore required when adjusting the spring to open the slide valve. In this case the component functions as an “external control valve”.

### Movement Control on One Cylinder

The situation depicted in FIG. 3A uses the external control valve function. Oil sent in the channel C1 passes through the check valve 81 and exits via the channel C2 to feed a steering cylinder of the detector circuit 3. The steering cylinder discharges a volume of oil in the channel D2, the oil being initially blocked by the valve 81′ and the pressure limiter 82′ which are non-passing. The pressure then rises in the line C1, C2 until the valve 82′ is opened and causes the return flow from the cylinder to the oil tank (that is to say from D2 to D1).

### External Effect on the Pressure Limiter Device

The situation depicted in FIG. 3B uses the anti-shock valve function of the two valves. Pressure may be created at C2 or D2 by a driving load (to support a weight), by an impact on the cylinder or by supply of hydraulic fluid in parallel.

If the pressures in C2 and D2 are lower than the pressure to which the valves 82, 82′ are set there is no flow through the pressure limiter device.

As depicted in FIG. 3C, as soon as the pressure at C2 or D2 exceeds the value to which the valve 82 or 82′ is set the corresponding valve 82′ is opened and allows escape of the volume of oil necessary for returning the pressure to an acceptable value. This volume is aspirated from the other side (from C1 to C2) by the other valve 82 via the check valve.

The invention is not limited to the embodiments depicted in the drawings.

Moreover, the term “comprising” does not exclude other elements or steps. Furthermore, features or steps that have been described with reference to one of the embodiments described hereinabove can also be used in combination with other features or steps of other embodiments described hereinabove.

1. A handling machine including:
a mobile chassis;
a handling system (64) comprising at least one handling member that can be actuated by a hydraulic cylinder (5), such as a cylinder for inclining a tool-holder of the machine;
a steering system comprising:
a hydraulic steering circuit (3) including steering cylinders (31-34) for steering at least some of the wheels of the machine;
a first hydraulic control circuit (100) connected to the steering circuit (3) to be able to feed the steering cylinders (31-34) and a manual steering device (4) such as a steering wheel connected to the first hydraulic control circuit (100);
a second hydraulic control circuit (200) used at least to control the actuator hydraulic cylinder (5) of a handling member;
characterized in that:
the second hydraulic control circuit (200) includes:
a hydraulic distributor (210);
a hydraulic connection circuit (600) connected to the hydraulic steering circuit (3); and
a diverter (220) to which are connected the connecting circuit (600), the hydraulic cylinder (5) for actuating a handling member, and the hydraulic distributor (210);
the diverter (220) being electrically controllable to assume selectively:
a first state in which the hydraulic distributor (210) of the second hydraulic control circuit (200) is connected to the actuator hydraulic cylinder (5) of said handling member; and
a second state in which the hydraulic distributor (210) of the second hydraulic control circuit (200) is connected to the connecting circuit (600) that is connected to the steering circuit (3) to enable the second hydraulic control circuit (200) to control the same steering cylinders as those controllable by the first hydraulic control circuit (100);
a control unit (10) configured to control the diverter (220) to place it in the second state in which the hydraulic distributor (210) is connected to the connecting circuit (600) that is connected to the steering circuit (3) in order to be able to execute a handling machine steering control program, for example for parking the handling machine automatically in a given place.

2. The handling machine as claimed in claim 1 in which the steering system is configured so that the first hydraulic control circuit (100) remains controllable by the driver of the handling machine using the manual steering device (4) to act on the steering circuit (3), complementing or correcting the second hydraulic control circuit (200).

3. The handling machine as claimed in either one of the preceding claims in which the first control circuit (100), the second control circuit (200) and the steering circuit (3) act on the same lines (L32, L300) of the steering circuit (3) so that the second control circuit (200) is adapted to act on the steering of the same wheels as those on which the first control circuit (100) is adapted to act, and vice versa.

4. The handling machine as claimed in any one of the preceding claims including front wheels and rear wheels, the steering circuit (3) being configured to enable steering of at least the front wheels.

5. The handling machine as claimed in any one of the preceding claims in which the second hydraulic control circuit (200) is connected to lines (L32, L300) of the steering circuit (3) that are connected to the first hydraulic control circuit (100).

6. The handling machine as claimed in any one of the preceding claims in which the steering circuit (3) includes a selector (300) for selecting the wheels to be steered.

7. The handling machine as claimed in any one of the preceding claims in which, the steering circuit (3) including a selector (300) for selecting the wheels to be steered, the second hydraulic control circuit (200) is connected to the steering circuit (3) between the first control circuit (100) and the selector (300).

8. The handling machine as claimed in any one of the preceding claims in which the steering circuit (3) includes a selector (300) configured to be able to adopt a plurality of states selectively, said states including:
a state in which the lines of the steering circuit (3) are configured so that only the front wheels are steerable with the aid of the hydraulic steering circuit;
a state in which the lines of the steering circuit (3) are configured so that the front wheels and the rear wheels are steerable in the same sense with the aid of the hydraulic steering circuit; and
a state in which the lines of the steering circuit (3) are configured so that the front wheels and the rear wheels are steerable in opposite senses to one another with the aid of the hydraulic steering circuit.

9. The handling machine as claimed in any one of claims 6 to 8 in which a line (L62) of the second hydraulic control circuit (200) is connected to a line (L300) of the steering circuit (3) that extends between the selector (300) and the first hydraulic control circuit (100).

10. The handling machine as claimed in the preceding claim in which another line (L61) of the second hydraulic control circuit (200) is connected to a line (L32) of the steering circuit (3) that extends between a steering cylinder (300), preferably a front wheel steering cylinder, and the first hydraulic control circuit (100).

11. The handling machine as claimed in any one of the preceding claims in which the hydraulic cylinder (5) for actuating a handling member is a cylinder for inclining a tool-holder of the handling machine.

12. The handling machine as claimed in any one of the preceding claims in which at least one of the first and second control circuits (100, 200) and preferably each of them includes a pressure limiter device (180, 680).

13. The handling machine as claimed in claim 12 in which at least one of the pressure limiter devices (180, 680) and preferably each of them includes a dual balancing valve.

14. The handling machine as claimed in either one of claim 12 or 13 in which the pressure limiter device (180) of the first control circuit (100) is situated between a steering pump (PDD) of the first control circuit (100) and the hydraulic steering circuit (3).

15. The handling machine as claimed in any one of claims 12 to 14 in which the pressure limiter device (680) of the second control circuit (200) is situated in the connecting circuit (600)
